(19) United States
(12) Patent Application Publication
(10) Pub. No.: US 2025/0377569 A1
(43) Pub. Date: Dec. 11, 2025

(54) DISPLAY DEVICE

(71) Applicant: Sharp Display Technology Corporation, Kameyama City (JP)

(72) Inventors: Takako KOIDE, Kameyama City (JP); Takashi SATOH, Kameyama City (JP)

(21) Appl. No.: 19/227,804

(22) Filed: Jun. 4, 2025

(30) Foreign Application Priority Data
Jun. 7, 2024 (JP) 2024-093055

(51) Int. Cl. G02F 1/1368; G02F 1/1362

(52) U.S. Cl. CPC G02F 1/1368; G02F 1/136227

(57) ABSTRACT

According to the disclosure, a display device includes a light source, a first substrate including a switching element including an oxide semiconductor layer, a display layer, and a second substrate, in this order from a back face side to an observation face side, and a plurality of pixels arranged in a matrix in a display region. The first substrate includes a reflective layer provided on the observation face side relative to the switching element, and a low-reflective layer disposed on the back face side of the reflective layer, at least a surface of the reflective layer on the back face side has an uneven shape, and each of the plurality of pixels includes a reflective region and a transmissive region, the reflective region is configured to reflect light at the reflective layer and to perform display, and the transmissive region is configured to transmit light and to perform display.

### CROSS-REFERENCE TO RELATED APPLICATIONS

This application claims the benefit of priority to Japanese Patent Application Number 2024-093055 filed on Jun. 7, 2024. The entire contents of the above-identified application are hereby incorporated by reference.

### BACKGROUND

### Technical Field

The disclosure relates to a display device.

Display devices are generally classified into a transmissive type and a reflective type according to image display systems. A transmissive display device performs display in a transmission mode by using transmitted light of light emitted from a backlight unit placed at the back face of a screen. A reflective display device performs display in a reflection mode by using external light (also referred to as ambient light) instead of backlight. The reflective display device does not need a backlight unit and thus can achieve low power consumption, a reduction in thickness, and a reduction in weight. On the other hand, the transmissive display device includes a light source on a back face side and thus has an advantage of high visibility even in dark environment.

With respect to the reflective display device, for example, JP 9-033918 A proposes a reflective liquid crystal panel in which a pixel electrode serving also as a reflector is formed on a substrate on a back face side through a light-blocking insulating film. In the reflective liquid crystal panel, in order to improve contrast and to improve OFF characteristics of a Thin Film Transistor (TFT), a light-blocking insulating film is provided on a glass substrate on the back face side so as to cover the TFT, thereby preventing the TFT from being irradiated with light.

### SUMMARY

In recent years, as display devices having both features of the transmissive type and the reflective type, transflective display devices have been proposed in which each pixel includes a region (transmissive region) for performing display in the transmission mode and a region (reflective region) for performing display in the reflection mode. Thus, the inventors have studied a transflective display device as follows.

First, as will be described later in Comparative Example 2, a liquid crystal display device 1R having a pixel structure illustrated in FIG. 11 was prepared. The liquid crystal display device 1R includes a backlight 40 on a back face side, and a reflective layer 140 having an uneven shape such as a Micro Reflective Structure (MRS). The reflective layer 140 is provided on a side of a substrate 10 positioned on the back face side, of a pair of substrates sandwiching a liquid crystal layer 20. As the reflective layer 140, a layered film of an SiN insulating layer and an aluminum film was used. This liquid crystal display device 1R was driven at 60 Hz or 0.01 Hz, the backlight 40 was turned on, the liquid crystal display device was placed in a thermostatic chamber at 60° C., and then, an accelerated aging test was carried out. In this case, a white luminance after the test was reduced by about 50% relative to a white luminance before the test in an example (Comparative Example 2-2) driven at 0.01 Hz. According to microscopic observation of the pixel at this time, it was found that the white luminance of the pixel to which a VL signal, of input signals of a high-level voltage VH and a low-level voltage VL, was input extremely decreased (see FIG. 14B). On the other hand, no abnormality was observed in an example (Comparative Example 2-1) in which the liquid crystal display device 1R was driven at 60 Hz (see FIG. 13B).

The inventors have considered that a cause of the decrease in the white luminance in Comparative Example 2-2 is that for example, light from the backlight unit, high-temperature environment, long-time application of a drive voltage VGL and the like causes off characteristics of a drive element (also referred to as a switching element) to deteriorate, and thus a voltage applied to the liquid crystal of the pixel input with a signal on the VL side decreases. Because of this, the inventors have proceeded to conduct a study about, in particular, the deterioration of the off characteristics by backlight further in details as follows.

Since a transflective display device uses light from the backlight unit, a TFT channel portion is typically configured to avoid reflection of the light from the backlight unit, for example, by increasing a gate size so that the light does not hit a semiconductor layer (also referred to as a channel portion) of a TFT or by disposing a reflective layer at a position not overlapping the TFT channel portion. However, when the reflective layer 140 has an uneven shape such as MRS on the back face side, the light from the backlight unit is diffusively reflected due to the uneven shape (see light L1 in FIG. 11 and FIG. 12), and the diffusively reflected light is directly or indirectly incident on the TFT channel portion, so that characteristics (in particular, the off characteristics) of the TFT are deteriorated. The deterioration in off characteristics of the TFT causes a state where a current flows from a gate of the TFT when the VL signal is input. In this state, a retention rate of the display layer (for example, a liquid crystal layer) significantly changes between the case where the input signal is the VH signal and the case where the input signal is the VL signal, and even in a case of driving at an identical gradation, the display layer becomes bright in the case of the VH signal and becomes dark in the case of the VL signal. Such a phenomenon is particularly noticeable in a case of low-frequency driving for suppressing power consumption (see FIG. 13B and FIG. 14B, which will be described later). For example, when the display device is driven at 60 Hz, since brightness and darkness are repeated every 16.7 milliseconds (msec), a repetition rate of brightness and darkness is too high at a certain level of luminance, and thus an observer hardly notices flickering. However, when the display device is driven at, for example, 1 Hz, brightness and darkness are repeated every second, so that display quality is lowered.

Note that as a measure for improving the off characteristics of the switching element, for example, as disclosed in JP 9-033918 A, it is conceivable to provide a light-blocking insulating film covering the TFT to prevent the TFT from being irradiated with light. However, since the transflective display device has a transmissive region, a light-blocking insulating film cannot be provided over the entire surface of the substrate. In addition, when a structure with insulating properties such as a light-blocking insulating film is provided in the display device, a capacitance is generated, which may affect driving of the display layer (for example, liquid crystal driving).

The disclosure has been made in view of the above-described circumstances, and an object of the present disclosure is to provide a transflective display device in which off characteristics of a switching element are favorable and display quality is excellent even when power consumption is low.
(1) An embodiment of the disclosure is a display device including a light source, a first substrate including a switching element including an oxide semiconductor layer, a display layer, and a second substrate, in this order from a back face side to an observation face side, and a plurality of pixels arranged in a matrix in a display region, in which the first substrate includes a reflective layer provided on the observation face side relative to the switching element, and a low-reflective layer disposed on the back face side of the reflective layer, at least a surface of the reflective layer on the back face side has an uneven shape, and each of the plurality of pixels includes a reflective region and a transmissive region, the reflective region is configured to reflect light at the reflective layer and to perform display, and the transmissive region is configured to transmit light and to perform display.
(2) In a display device according to an embodiment of the disclosure, in addition to the configuration (1), the low-reflective layer is disposed in contact with the reflective layer.
(3) In a display device according to an embodiment of the disclosure, in addition to the configuration (1) or (2), the first substrate includes an interlayer insulating layer between a source bus line and a drain wiring line each of which is electrically connected to the switching element and the low-reflective layer.
(4) In a display device according to an embodiment of the disclosure, in addition to the configuration (1), (2), or (3), the first substrate includes an interlayer insulating layer on the observation face side of the switching element, each of the pixels includes a pixel electrode electrically connected to the switching element through a contact hole provided at the interlayer insulating layer, and in the reflective region of each of the pixels, the low-reflective layer and the pixel electrode are disposed on the back face side of the reflective layer in an order of the low-reflective layer and the pixel electrode.
(5) In a display device according to an embodiment of the disclosure, in addition to the configuration of (1), (2), (3), or (4), the low-reflective layer is a metal layer made of a metal having a reflectivity of 50% or less when measured at a film thickness of 200 nm.
(6) In a display device according to an embodiment of the disclosure, in addition to the configuration (1), (2), (3), or (4), the low-reflective layer is a multilayer film including a metal layer and a transparent insulating layer, and the metal layer is made of a metal having a reflectivity of 50% or less when measured at a film thickness of 200 nm.
(7) In a display device according to an embodiment of the disclosure, in addition to the configuration (4), the low-reflective layer is a multilayer film including a metal layer and a transparent insulating layer, and the metal layer is made of a metal having a reflectivity of 50% or less when measured at a film thickness of 200 nm, and the low-reflective layer is not disposed at a bottom of the contact hole.
(8) In a display device according to an embodiment of the disclosure, in addition to the configuration (5), the low-reflective layer has a planar pattern being substantially identical to a planar pattern of the reflective layer, when viewed from the observation face side.
(9) In a display device according to an embodiment of the disclosure, in addition to the configuration (6) or (7), a portion other than a portion provided with the contact hole, of the low-reflective layer, has a planar pattern being substantially identical to a planar pattern of the reflective layer when viewed from the observation face side.
(10) In a display device according to an embodiment of the disclosure, in addition to (5) or (8), the metal is at least one selected from the group consisting of titanium, copper, molybdenum, and tungsten, or an alloy of the at least one selected from the group.
(11) In a display device according to an embodiment of the disclosure, in addition to the configuration (6) or (9), the metal is at least one selected from the group consisting of titanium, copper, molybdenum, and tungsten, or an alloy of the at least one selected from the group, the transparent insulating layer is a nitride film, and the multilayer film includes the metal layer and the nitride film.
(12) In a display device according to an embodiment of the disclosure, in addition to the configuration (7) or (9), the metal is at least one selected from the group consisting of titanium, copper, molybdenum, and tungsten, or an alloy of the at least one selected from the group, the transparent insulating layer is a nitride film, and the multilayer film includes the metal layer and the nitride film.
(13) In a display device according to an embodiment of the disclosure, in addition to the configuration (1), (2), (3), (4), (5), (6), (7), (8), (9), (10), (11), or (12), at least a surface of the low-reflective layer on the back face side has an uneven shape.
(14) In a display device according to an embodiment of the disclosure, in addition to the configuration (1), (2), (3), (4), (5), (6), (7), (8), (9), (10), (11), (12), or (13), the first substrate includes a flattening film on the observation face side of the reflective layer.
(15) In a display device according to an embodiment of the disclosure, in addition to the configuration (1), (2), (3), (4), (5), (6), (7), (8), (9), (10), (11), (12), (13), or (14), in the reflective region of each of the pixels, an interlayer insulating layer is provided between the switching element and the low-reflective layer, and the reflective layer and the low-reflective layer are disposed at a position overlapping a gate electrode of the switching element in a plan view.
(16) In a display device according to an embodiment of the disclosure, in addition to the configuration (1), (2), (3), (4), (5), (6), (7), (8), (9), (10), (11), (12), (13), (14), or (15), the display layer is a liquid crystal layer.
(17) In a display device according to an embodiment of the disclosure, in addition to the configuration (1), (2), (3), (4), (5), (6), (7), (8), (9), (10), (11), (12), (13), (14), (15), or (16), the display device further includes a drive circuit configured to drive the display device, and the drive circuit is configured to switch between a first drive mode and a second drive mode, and in the first drive mode, the display device is configured to be driven at a first frequency, and in the second drive mode, the display device is configured to be driven at a second frequency lower than the first frequency.
(18) In a display device according to an embodiment of the disclosure, in addition to the configuration (17), the light source is turned on in the second drive mode.
(19) In a display device according to an embodiment of the disclosure, in addition to the configuration (1), (2), (3), (4), (5), (6), (7), (8), (9), (10), (11), (12), (13), (14), (15), (16), (17) or (18), the oxide semiconductor layer includes InGaZnOx including indium (In), gallium (Ga), zinc (Zn), and oxygen (O) as main components.

According to the disclosure, it is possible to provide a transflective display device in which off characteristics of a switching element are favorable and display quality is excellent even when power consumption is low.

### BRIEF DESCRIPTION OF DRAWINGS

The disclosure will be described with reference to the accompanying drawings, wherein like numbers reference like elements.

FIG. 1 is a schematic cross-sectional view illustrating a structure of a display device 1 according to first to fifth embodiments.

FIG. 2 is a schematic cross-sectional view of a pixel included in the display device 1 according to the first embodiment.

FIG. 3 is a schematic plan view conceptually illustrating that each pixel P includes a reflective region Rf and a transmissive region Tr in the display device 1 according to the first to fifth embodiments.

FIG. 4 is a schematic cross-sectional view of a pixel included in the display device 1 according to the second embodiment.

FIG. 5 is a schematic cross-sectional view illustrating a configuration example of a low-reflective layer 130 included in the display device 1 according to the second embodiment.

FIG. 6 is a schematic plan view of respective layers in a portion a surrounded by a broken line in FIG. 4.

FIG. 7 is a schematic cross-sectional view of a pixel included in the display device 1 according to the third embodiment.

FIG. 8 is a schematic cross-sectional view of a pixel included in the display device 1 according to the fourth embodiment.

FIG. 9 is a schematic cross-sectional view of a pixel included in the display device 1 according to an example of the fifth embodiment.

FIG. 10 is a schematic cross-sectional view of a pixel included in the display device 1 according to an example of a sixth embodiment.

FIG. 11 is a schematic cross-sectional view of a pixel included in a liquid crystal display device 1R according to Comparative Example 1 and Comparative Example 2.

FIG. 12 is a graph showing a simulation result of Comparative Example 1.

FIG. 13A is a diagram conceptually illustrating signals input to respective pixels included in the liquid crystal display device 1R according to Comparative Example 2-1.

FIG. 13B is a close-up photograph of a black-and-white pattern after the liquid crystal display device 1R according to Comparative Example 2-1 is subjected to an accelerated aging test.

FIG. 14A is a diagram conceptually illustrating signals input to respective pixels included in the liquid crystal display device 1R according to Comparative Example 2-2.

FIG. 14B is a close-up photograph of a black-and-white pattern after the liquid crystal display device 1R according to Comparative Example 2-2 is subjected to an accelerated aging test.

FIG. 15 is a graph showing simulation results of Example 1.

FIG. 16 is a graph showing simulation results of Example 2.

FIG. 17 is a graph showing simulation results of Example 2.

FIG. 18 is a graph showing simulation results of Example 3.

FIG. 19 is a graph showing simulation results of Example 4.

FIG. 20 is a graph showing simulation results of Example 5.

### DESCRIPTION OF EMBODIMENTS

### Definition of Terms

In this specification, an “observation face side” refers to a side closer to a screen (display surface) of a display device (that is, a side on which an observer is positioned), and a “back face side” refers to a side farther from the screen (display surface) of the display device.

A display device according to an embodiment of the disclosure will be described below. The disclosure is not limited to the contents described in the following embodiments, and appropriate design changes can be made within the scope that satisfies the configuration according to the disclosure. Note that in the description below, the same reference signs are appropriately used in common among the different drawings for the same parts or parts having similar functions, and repeated description thereof will be omitted as appropriate. The aspects of the disclosure may be combined as appropriate within the range that does not depart from the gist of the disclosure.

Hereinafter, embodiments in which the display device 1 is a liquid crystal display device, that is, embodiments in which a display layer 20 is a liquid crystal layer will be mainly described. However, the display device 1 according to the disclosure is not particularly limited thereto as long as the display device includes a backlight and a reflective layer. Examples of the display device 1 according to the disclosure include, in addition to the liquid crystal display device, a Micro Electro Mechanical System Display (MEMS Display) or the like.

### First Embodiment

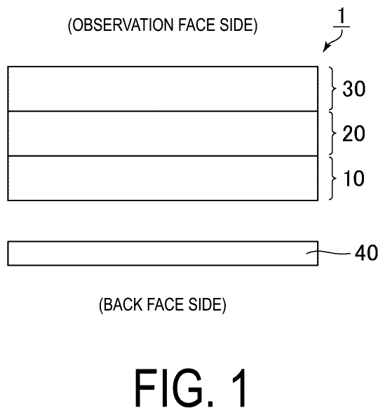

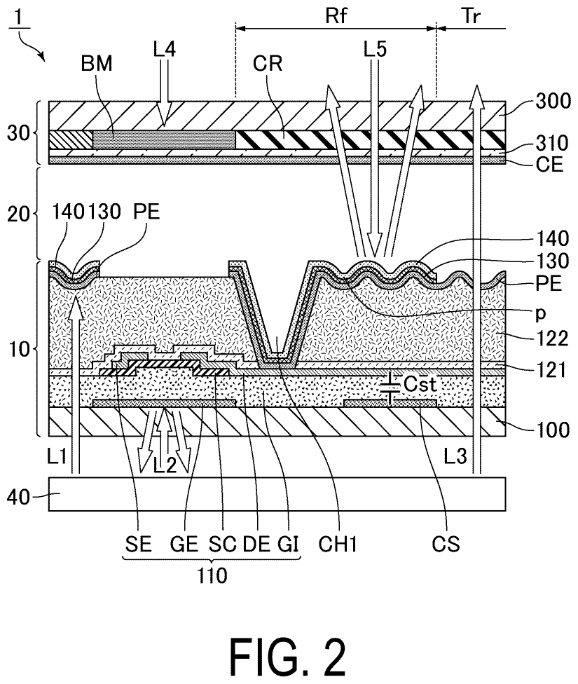

FIG. 1 is a schematic cross-sectional view illustrating a structure of the display device 1 according to the present embodiment (and second to fifth embodiments, which will be described later), and FIG. 2 is a schematic cross-sectional view of a pixel included in the display device 1 according to the present embodiment. The display device 1 according to the present embodiment includes a light source 40, a first substrate 10, a display layer 20, and a second substrate 30 in this order from a back face side toward an observation face side.

The light source 40 disposed on the back face side is also referred to as a backlight. The light source 40 is not particularly limited as long as the light source 40 emits light, and may be a direct type, an edge type, or any other type. For example, the light source 40 preferably includes a light source such as a Light Emitting Diode (LED), a light guide plate, and a reflective sheet, and may further include a diffuser sheet or a prism sheet.

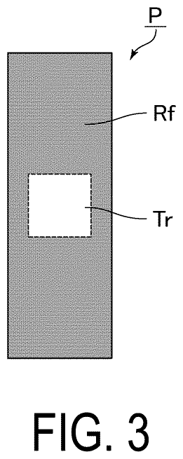

The display device 1 includes a plurality of pixels P arranged in a matrix in a display region. Although the plurality of pixels P typically include three types of pixels, that is, a red pixel, a green pixel, and a blue pixel, the number of types of pixels may be two or less or four or greater. Each pixel P includes a reflective region Rf for display by reflecting light (that is, a region for display in a reflection mode) at the reflective layer 140 and a transmissive region Tr for display by transmitting light (a region for display in a transmission mode) (see FIG. 3). This makes it possible to exhibit favorable viewability in any environment. FIG. 3 is a schematic plan view conceptually illustrating that each pixel P includes the reflective region Rf and the transmissive region Tr in the display device 1 according to the present embodiment (and the second to fifth embodiments, which will be described later).

A proportion of an area occupied by the transmissive region Tr (aperture ratio) in each pixel P can be set as appropriate depending on an application or the like, but is preferably 5% or more and 95% or less, for example, when the area of one pixel P is taken as 100%. A position and a shape of the transmissive region Tr within the pixel P may also be appropriately set depending on the application or the like.

The reflective layer 140 is disposed in the reflective region Rf (see FIG. 2). In the reflective region Rf, light from the observation face side enters the display device 1, is reflected at the reflective layer 140, and then is emitted from the observation face side (see light L5). When the second substrate 30 includes a light blocking portion such as a black matrix layer BM, light from the observation face side enters the display device 1 and then is absorbed by the black matrix layer BM (see light L4). In addition, light from the backlight unit is blocked by the low-reflective layer 130 before entering the reflective layer 140, and reflection of the light from the backlight unit is sufficiently suppressed (see light L1). On the other hand, the reflective layer 140 is not disposed in the transmissive region Tr (see FIG. 2). In the transmissive region Tr, light from the backlight unit is transmitted through the display layer 20 and is emitted from the observation face side (see light L3). Light from the backlight unit may also be reflected at, for example, a gate electrode GE of a TFT 110 or the like and emitted from the back face side (see light L2). Arrows in FIG. 2 indicate an optical path and a traveling direction of light from the observation face side (for example, external light) or light from the back face side (for example, light from the backlight unit).

The first substrate 10 is formed with a switching element 110 including an oxide semiconductor layer SC, the low-reflective layer 130, the reflective layer 140, a pixel electrode PE, and the like on a surface of a support substrate 100. In the present embodiment, a thin film transistor (also referred to as a TFT) is used as the switching element 110. The TFT 110 includes the oxide semiconductor layer SC and TFT electrodes. The TFT electrodes include terminals of the TFT 110 (a gate, a source, and a drain) and wiring lines electrically connected to the respective terminals, and made of a metal or an alloy. An insulating layer (also referred to as an insulating film) may be provided between the layers and the like (for example, a gate insulating film GI, interlayer insulating layers 121 to 125, and the like).

The TFT 110 is provided in each of the plurality of pixels P. The luminance of each pixel P is controlled by controlling a voltage to be applied to the pixel electrode PE. The pixel electrode PE is electrically connected to a drain electrode DE of the TFT 110, and the drain electrode DE is connected to a source electrode SE through the oxide semiconductor layer SC. A current flowing through the oxide semiconductor layer SC is controlled by a voltage applied to the gate electrode GE. The gate electrode GE, the source electrode SE, and the drain electrode DE are included in the TFT electrodes.

The oxide semiconductor included in the oxide semiconductor layer SC contains, for example, at least one metal element selected from indium (In), gallium (Ga), and zinc (Zn). As the oxide semiconductor, specifically, a compound (In—Ga—Zn—O) made of In, Ga, Zn, and oxygen (O), a compound (In-Tin-Zn—O) made of In, tin (Tin), Zn, and O, a compound (In—Al—Zn—O) made of In, aluminum (Al), Zn, and O, or the like may be used. Among these, In—Ga—Zn—O is preferable.

As described above, the oxide semiconductor layer SC is preferably a layer containing InGaZnOx, which contains In, Ga, Zn, and O as main components. Here, a proportion (composition ratio) of In, Ga, and Zn is not particularly limited thereto, and for example, In:Ga:Zn=2:2:1, In:Ga:Zn=1:1:1, In:Ga:Zn=1:1:2, and the like may be exemplified. InGaZnOx may be amorphous or crystalline. As InGaZnOx that is crystalline, a c-axis is suitably oriented approximately perpendicular to a layer surface.

The reflective layer 140 is provided on the observation face side relative to the TFT 110, and the low-reflective layer 130 is provided on the back face side of the reflective layer 140. That is, the TFT 110, the low-reflective layer 130, and the reflective layer 140 are disposed in this order from the back face side toward the observation face side. One or more interlayer insulating films are provided between the TFT 110 and the low-reflective layer 130. To be more specific, the first substrate 10 preferably includes an interlayer insulating layer (a first interlayer insulating layer 121 and a second interlayer insulating layer 122 in FIG. 2) between a source bus line SE and a drain wiring line DE that are electrically connected to the TFT 110 and the low-reflective layer 130. Since the low-reflective layer 130 is disposed on the reflective layer 140 side relative to the source bus line SE and the drain wiring line DE, the display device 1 can more remarkably exhibit an effect of suppressing reflection of light from the backlight unit and thus suppressing deterioration in TFT characteristics (in particular, off characteristics).

At least a surface of the reflective layer 140 on the back face side has an uneven shape (also referred to as an uneven surface structure). The uneven surface structure is also called Micro Reflective Structure (MRS), and is provided to diffusely reflect ambient light and achieve white display close to paper white. The uneven surface structure is preferably configured of a plurality of protruding portions p randomly arranged, for example, such that a center interval between the adjacent protruding portions p is 5 μm or greater and 50 μm or less. A center interval between the adjacent protruding portions p is more preferably 10 μm or more and 20 μm or less. A shape of each protruding portion p is substantially circular or substantially polygonal when viewed from a normal direction of the support substrate 100. An area of the protruding portion p occupying one pixel P is preferably about 20 to 40%, for example, and a height of the protruding portion p is preferably 1 μm or greater and 5 μm or less, for example. A surface of the reflective layer 140 on the observation face side may or need not have an uneven shape.

The reflective layer 140 is made of a material that reflects light. The reflective layer 140 is preferably made of a metal material having high reflectivity. Examples of the material of the reflective layer 140 include aluminum (Al), silver (Ag), a silver alloy and an aluminum alloy.

A thickness (a total thickness in a case of a layered structure) of the reflective layer 140 is not particularly limited and is, for example, 1 nm to 1 μm.

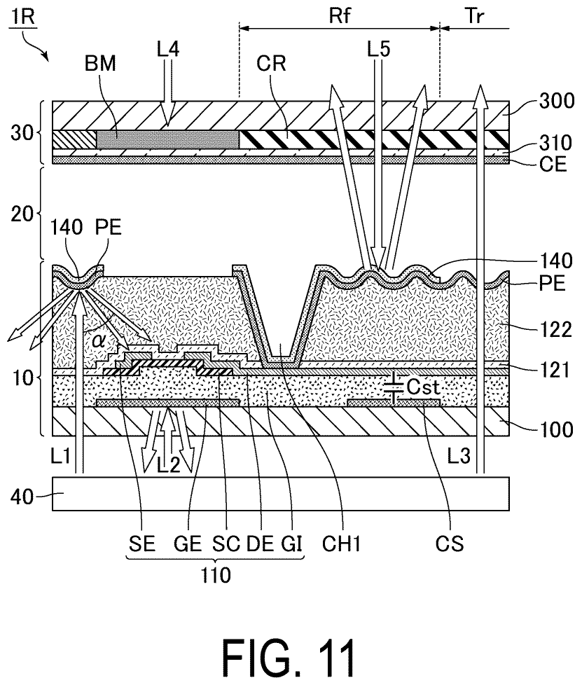

The low-reflective layer 130 is disposed on the back face side of the reflective layer 140. In the display device 1 that does not include the low-reflective layer 130, when the light L1 from the backlight unit hits the reflective layer 140, the light L1 may be reflected and enter the TFT channel portion (see FIG. 11). Since TFT characteristics are different between a case where light from the backlight unit enters the TFT channel portion and a case where light from the backlight unit does not enter the TFT channel portion, the display quality of such a display device 1 is not favorable. In particular, when the surface of the reflective layer 140 on the back face side has an uneven shape, light is diffusely reflected and easily reaches the TFT channel portion, and thus the influence of reflection of light from the backlight unit increases (see FIG. 11). However, in the present embodiment, since the low-reflective layer 130 is disposed on the back face side of the reflective layer 140, as described above, the reflection of light from the backlight unit is sufficiently suppressed (see FIG. 2). Thus, since the light entering the TFT channel portion is sufficiently suppressed, the display device 1 according to the present embodiment can satisfactorily exhibit TFT characteristics (particularly, off characteristics) even when power consumption is low, and can exhibit high display quality.

From the viewpoint of further exhibiting the effect by the low-reflective layer 130, the low-reflective layer 130 is preferably disposed in contact with the reflective layer 140. However, one or more transparent layers 150 (for example, a transparent electrode or a transparent insulating layer) may be interposed between the low-reflective layer 130 and the reflective layer 140 (see a sixth embodiment, which will be described later). The low-reflective layer 130 may be disposed on the back face side of a part of the reflective layer 140, but is preferably disposed on the back face side of the entire surface of the reflective layer 140 in consideration of cost and efficiency in manufacturing the display device 1.

In the present embodiment, the low-reflective layer 130 is a metal layer made of an electrically conductive metal. When the metal layer is used for the low-reflective layer 130, the low-reflective layer 130 does not contribute to formation of a holding capacitance Cst, and thus an undesirable possibility of affecting driving of the display layer (for example, driving of the liquid crystal) is suppressed. In particular, the low-reflective layer 130 is preferably a metal layer made of a metal having a reflectivity of 50% or less when measured at a film thickness of 200 nm. Such a low-reflective layer 130 has a high antireflective effect. The metal layer may have a single-layer structure made of only one type of metal, or a layered structure made of two or more types of metals. Note that “a metal having a reflectivity of 50% or less when measured at a film thickness 200 nm” may be an alloy. Table 1 below shows a reflectivity measured at the film thickness of 200 nm for each metal type.

TABLE 1

| Metal type | Reflectivity |
|---|---|
| Ag | 94% |
| Al | 88% |
| Mo | 43% |
| Ti | 38% |
| W | 35% |
| TaN | 35% |
| Ta | 23% |

As shown in Table 1 described above, molybdenum (Mo), titanium (Ti), tungsten (W), tantalum nitride (TaN), and tantalum (Ta) are examples of the metal having the reflectivity of 50% or less when measured at the film thickness of 200 nm. On the other hand, the reflectivities of Ag and Al significantly exceed 50% and are higher than the reflectivities of the other metal types even in the form of a thin film. Thus, when these metals are used, an amount of light reflected at the low-reflective layer 130 may become excessively large.

The metal having the reflectivity of 50% or less when measured at the film thickness of 200 nm is particularly preferably at least one selected from the group consisting of titanium (Ti), copper (Cu), molybdenum (Mo) and tungsten (W), or an alloy thereof.

The thickness of the low-reflective layer 130 is not limited, and is preferably, for example, from 1 nm to 1 μm. A lower limit of the thickness of the low-reflective layer 130 is, for example, more preferably 5 nm or more, and still more preferably 10 nm or more.

It is preferable that at least the surface on the observation face side (that is, the surface on the reflective layer 140 side) of the low-reflective layer 130 have an uneven shape (uneven surface structure), and it is more preferable that both the surface on the observation face side and the surface on the back face side of the low-reflective layer 130 have uneven shapes. In the present embodiment, it is preferable that the low-reflective layer 130 have substantially the same planar pattern as the reflective layer 140 when viewed from the observation face side. The reflective layer 140 and the low-reflective layer 130 are preferably individually patterned.

The pixel electrode PE is preferably disposed between the TFT 110 and the low-reflective layer 130. That is, in the reflective region Rf of each pixel P, it is preferable that the low-reflective layer 130 and the pixel electrode PE be disposed on the back face side of the reflective layer 140 in the order of the low-reflective layer 130 and the pixel electrode PE from the reflective layer 140 side.

One or more transparent layers (for example, a transparent electrode or an interlayer insulating film) may be disposed between the pixel electrode PE and the low-reflective layer 130, but it is preferable that the pixel electrode PE be disposed in contact with the low-reflective layer 130. In addition, it is preferable that at least the surface of the pixel electrode PE on the back face side have an uneven shape (uneven surface structure), and it is more preferable that both the surface on the observation face side and the surface on the back face side of the pixel electrode PE have uneven shapes. By using an organic insulating film having an uneven surface structure as at least one layer (for example, the second interlayer insulating layer 122 in FIG. 2) of the interlayer insulating layers disposed between the pixel electrode PE and the TFT 110, the layers and the like (the pixel electrode PE, the low-reflective layer 130, and the reflective layer 140 in the present embodiment) positioned on the observation face side of the interlayer insulating layer can have uneven shapes reflecting the uneven surface structure.

As described above, one or two or more interlayer insulating layers are preferably disposed between the TFT 110 and the pixel electrode PE. In FIG. 2, the first interlayer insulating layer 121 and the second interlayer insulating layer 122 are provided between the TFT 110 and the pixel electrode PE. A contact hole CH1 is formed at the interlayer insulating layers disposed between the pixel electrode PE and the TFT 110, and the pixel electrode PE is electrically connected to the TFT 110 through the contact hole CH1. In the reflective region Rf of each pixel P, the first substrate 10 preferably includes the switching element 110, the interlayer insulating layers (the first interlayer insulating layer 121 and the second interlayer insulating layer 122 in FIG. 2), the pixel electrode PE, the low-reflective layer 130, and the reflective layer 140 in this order from the back face side toward the observation face side (see FIG. 2).

The pixel electrode PE is preferably a transparent electrode. The transparent electrode can be formed using, for example, an electrically conductive material that is transparent such as indium tin oxide (ITO), indium zinc oxide (IZO), zinc oxide (ZnO), or tin oxide (SnO), or an alloy thereof.

Note that the display device 1 according to the second embodiment, which will be described later, has a structure in which the low-reflective layer 130 is not disposed at the bottom of the contact hole CH1 because the low-reflective layer 130 includes a transparent insulating layer 132. However, in the present embodiment, since the low-reflective layer 130 is a metal layer, the low-reflective layer 130 may be disposed at the bottom of the contact hole CH1, or the low-reflective layer 130 need not be disposed as in the second embodiment.

The insulating layer is preferably a layer made of an organic insulating material or an inorganic insulating material. Examples of the organic insulating film obtained by using the organic insulating material include an organic film (with a relative dielectric constant ε=2 to 5) such as acrylic resin, polyimide resin, and novolac resin, and a layered body thereof. A film thickness of the organic insulating film is not particularly limited, but is 2 μm or more and 4 μm or less, for example. Examples of the inorganic insulating films obtained by using the inorganic insulating material include an inorganic film (with a relative dielectric constant ε=5 to 7) such as silicon nitride (SiNx) and silicon oxide (SiO₂), and a layered film thereof. A film thickness of the inorganic insulating film is not particularly limited, but is 1500 Å or more and 3500 Å or less, for example. As the insulating layer, a layered body of the organic insulating film and the inorganic insulating film may be used. Among the insulating layers, the gate insulating film GI is preferably the inorganic insulating film, the first interlayer insulating layer 121 disposed so as to cover the TFT 110 is preferably the inorganic insulating film, and the second interlayer insulating layer 122 (and the interlayer insulating layers 123 to 125, which will be described later, or the like) disposed on the observation face side relative to the first interlayer insulating layer 121 is preferably the organic insulating film. In addition, each insulating layer preferably has high transparency and is preferably made of a material having a high transmittance.

The second substrate 30 is a substrate disposed so as to face the first substrate 10. For example, the second substrate 30 is obtained by forming a color resist layer CR, a black matrix layer BM, a common electrode CE, and the like on a surface of a support substrate 300. The color resist layer CR may include a color filter for one or more colors (for example, red, green, blue, and the like). Note that although FIG. 2 illustrates an example of the pixel structure of the display device 1 that performs color display, the display device 1 of the present embodiment may perform monochrome display, and the second substrate 30 need not include the color resist layer CR. Further, at least one of the color resist layer CR and the black matrix layer BM may be disposed on the first substrate 10.

The common electrode CE is preferably a transparent electrode. The transparent electrode is as described above. Additionally, the second substrate 30 may include an overcoat layer 310. The overcoat layer 310 is preferably an insulating film, and more preferably an organic insulating film. Details of the organic insulating film are as described above.

Each of the support substrate 100 and the support substrate 300 is preferably a substrate being transparent and having an insulating property, and for example, is preferably a glass substrate or a plastic substrate.

The display layer 20 is disposed between the first substrate 10 and the second substrate 30 (see FIG. 1 and FIG. 2). The first substrate 10 or the second substrate 30 and the display layer 20 may be in direct contact with each other, or one or more other layers (for example, an alignment film) may be disposed between the first substrate 10 or the second substrate 30 and the display layer 20.

The display layer 20 is a layer that performs display by controlling the passage of visible light, and is also referred to as an optical shutter layer. Although the display layer 20 is a liquid crystal layer in the present embodiment, the display layer 20 may be a shutter layer that controls blocking or transmitting of light by sliding a shutter body. In particular, the display layer 20 is preferably a liquid crystal layer.

When the display layer 20 is a liquid crystal layer, that is, when the display device 1 is a liquid crystal display device, the liquid crystal display mode is not particularly limited, and may be any liquid crystal display mode such as a Vertical Alignment (VA) mode, a horizontal alignment (ECB) mode, a Twisted Nematic (TN) mode, a Fringe Field Switching (FFS) mode, or an In-Plane Switching (IPS) mode, for example. Note that the pixel structure illustrated in FIG. 2 is an example of the VA mode.

The display device 1 preferably includes a drive circuit (not illustrated) that drives the display device 1, and the drive circuit is preferably capable of switching between a first drive mode and a second drive mode. In the first drive mode, the display device 1 is driven at a first frequency H1 and in the second drive mode, the display device 1 is driven at a second frequency H2 lower than the first frequency H1. It is preferable that the light source 40 be turned on in the second drive mode. For example, the first frequency H1 is from 30 Hz to 120 Hz, and the second frequency H2 is from 0.001 Hz to 30 Hz (where H2<H1 holds). The display device 1 according to the present embodiment has favorable TFT characteristics and excellent display quality even when driven at a low frequency.

In addition to the above-described layers, members, and the like, the display device 1 may further include, for example, an optical film such as a polarizer, a retarder, a viewing angle enhancement film, or a luminance enhancement film; an external circuit such as a Tape Carrier Package (TCP) or a Printed Circuit Board (PCB); a bezel (frame); and the like. Such members are not particularly limited thereto, and those commonly used in the field of display devices can be used, and thus, description will be omitted.

Next, a preferred manufacturing method for the display device 1 according to the present embodiment will be described.

The display device 1 can be obtained by individually preparing the first substrate 10 and the second substrate 30, and then bonding these substrates with the display layer 20 interposed therebetween. For example, when the display layer 20 is a liquid crystal layer, a liquid crystal material is injected between the first substrate 10 and the second substrate 30 by a general method, thereby obtaining a liquid crystal display device. Note that the second substrate 30 can be prepared according to a manufacturing method for a general color filter substrate.

The first substrate 10 is prepared, for example, according to a manufacturing method for a general transflective display device, and the TFT 110 is prepared, for example, according to a method for preparing a TFT using a general inverted staggered type oxide semiconductor. Specifically, as the method for preparing the first substrate 10, the following manufacturing method is preferably adopted. That is, the gate insulating film GI is disposed after a gate electrode and a wiring line pattern of the TFT 110 are prepared, on the support substrate 100. Next, after the oxide semiconductor layer SC is formed and a source/drain electrode pattern is formed, the first interlayer insulating layer 121 constituted by, for example, an inorganic insulating film is formed by deposition patterning. Thereafter, an organic insulating film is applied to form the second interlayer insulating layer 122, and patterning is performed using a halftone mask or the like, thereby forming the uneven shape of the MRS on the surface of the second interlayer insulating layer 122 on the observation face side. Thereafter, a transparent electrode (for example, ITO) is formed as the pixel electrode PE, and further, the reflective layer 140 is formed. Note that as described above, the reflective layer 140 and the low-reflective layer 130 preferably have substantially the same planar pattern, and the reflective layer 140 and the low-reflective layer 130 are preferably individually patterned. In this manner, the first substrate 10 is suitably prepared.

Note that the reflective layer 140 is not disposed in the transmissive region Tr in each pixel P. For example, the reflective region Rf including the reflective layer 140 and the transmissive region Tr not including the reflective layer 140 can be formed by forming the reflective layer 140 and the like and then removing a part of the reflective layer 140 in manufacturing the first substrate 10. It is preferable that neither the reflective layer 140 nor the low-reflective layer 130 be disposed in the transmissive region Tr.

### Second Embodiment

In the first embodiment, the low-reflective layer 130 is a metal layer made of an electrically conductive metal, but in the present embodiment, the low-reflective layer 130 is a multilayer film including the metal layer and a transparent insulating layer. Since the present embodiment is substantially similar to the first embodiment except for this point, description of matters common to those of the first embodiment will be omitted.

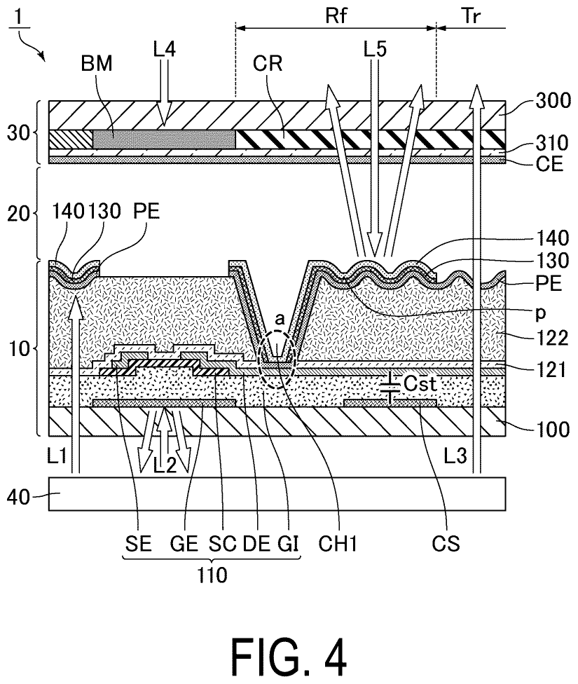

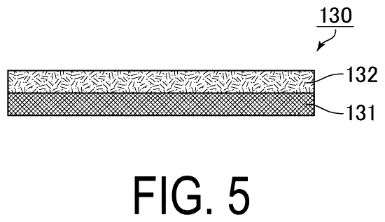

FIG. 4 is a schematic cross-sectional view of a pixel included in the display device 1 according to the present embodiment. FIG. 5 is a schematic cross-sectional view illustrating a configuration example of the low-reflective layer 130. As illustrated in FIG. 5, the low-reflective layer 130 is a multilayer film including a metal layer 131 made of an electrically conductive metal and a transparent insulating layer 132. In particular, the low-reflective layer 130 is preferably a multilayer film including the metal layer 131 made of a metal having a reflectivity of 50% or less in measurement at a film thickness of 200 nm and the transparent insulating layer 132. The multilayer film may include one or two or more metal layers 131 and may include one or two or more transparent insulating layers 132. A positional relationship between the metal layer 131 and the transparent insulating layer 132 is not particularly limited, but it is preferable that at least the metal layer 131 be positioned on the back face side relative to the transparent insulating layer 132.

Details of the metal layer 131 are as described in the first embodiment. The transparent insulating layer 132 is preferably a layer made of an organic insulating material or an inorganic insulating material, and details of the film obtained by using these materials are as described above. In particular, the transparent insulating layer 132 is preferably an inorganic insulating film, more preferably a nitride film (for example, a silicon nitride film).

In particular, it is preferable that the metal having the reflectivity of 50% or less in the measurement at the film thickness of 200 nm be at least one selected from the group consisting of titanium (Ti), copper (Cu), molybdenum (Mo) and tungsten (W), or an alloy thereof, the transparent insulating layer 132 be a nitride film, and the multilayer film (that is, the low-reflective layer 130) be constituted by the metal layer 131 made of the metal and the nitride film 132. Particularly preferable examples of the low-reflective layer 130 include a layered film of titanium and a nitride film, a layered film of molybdenum and a nitride film, a layered film of tungsten and a nitride film, and a layered film of molybdenum, a nitride film, and tungsten.

A thickness of the low-reflective layer 130 (a total thickness of the multilayer film) is not particularly limited, and is preferably, for example, from 1 nm to 1 μm. In particular, a thickness of the metal layer 131 is preferably 1 nm or more, more preferably 5 nm or more, and is preferably 500 nm or less, more preferably 100 nm or less. A thickness of the transparent insulating layer 132 is preferably 1 nm or more, more preferably 10 nm or more, still more preferably 50 nm or more, particularly preferably 100 nm or more, and is preferably 500 nm or less.

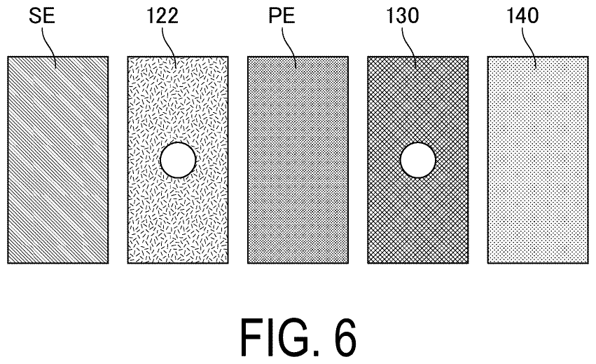

The pixel electrode PE is electrically connected to the TFT 110 through the contact hole CH1 provided at the interlayer insulating layer. In the present embodiment, the low-reflective layer 130 is not disposed at the bottom of the contact hole CH1. Since the low-reflective layer 130 includes the transparent insulating layer 132, the contact hole CH1 does not function when the low-reflective layer 130 is present at the bottom of the contact hole CH1. FIG. 6 is a plan view illustrating respective layers in the vicinity of the contact hole CH1. As illustrated in FIG. 6, a portion of the low-reflective layer 130 corresponding to the bottom of the contact hole CH1 is removed to form an opening. FIG. 6 is a schematic plan view illustrating the respective layers in a portion a surrounded by a broken line in FIG. 4.

In the present embodiment, it is preferable that a portion other than a portion provided with the contact hole CH1, of the low-reflective layer 130, have a planar pattern substantially identical to that of the reflective layer 140 when viewed from the observation face side. Also in the present embodiment, the reflective layer 140 and the low-reflective layer 130 are preferably individually patterned.

### Third Embodiment

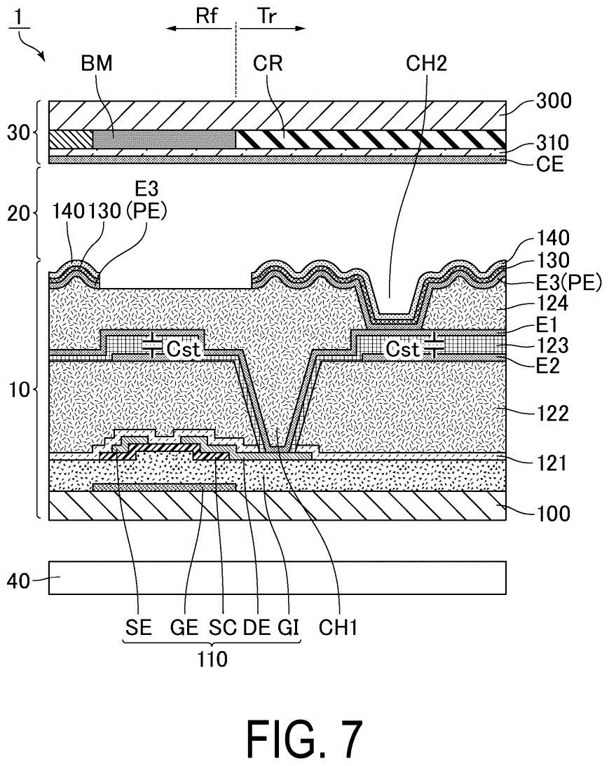

In the first and second embodiments, the holding capacitance Cst is formed between the TFT electrodes (that is, between an auxiliary capacitance line CS and the drain electrode DE). In the present embodiment, the holding capacitance Cst is formed between a first transparent electrode E1 connected to the TFT electrode through the contact hole (referred to as a first contact hole) CH1 and a second transparent electrode E2 facing the first transparent electrode E1 (see FIG. 7). The present embodiment is substantially similar to the first embodiment or the second embodiment mainly except for this point, and thus description of matters common to those of the first and second embodiments will be omitted.

FIG. 7 is a schematic cross-sectional view of a pixel included in the display device 1 according to the present embodiment. As in the first and second embodiments, the first interlayer insulating layer 121 is disposed so as to cover the TFT 110, the second interlayer insulating layer 122 is disposed on the observation face side of the first interlayer insulating layer 121, and the first contact hole CH1 is formed at the second interlayer insulating layer 122. In the present embodiment, the TFT electrode and the first transparent electrode E1 are connected to each other through the first contact hole CH1. A fourth interlayer insulating layer 124 is disposed on the observation face side of the first transparent electrode E1. Between the second interlayer insulating layer 122 formed with the first contact hole CH1 and the first transparent electrode E1, the second transparent electrode E2 (a common potential) forming the holding capacitance Cst with the first transparent electrode E1 is disposed. Further, between the first transparent electrode E1 and the second transparent electrode E2, a third interlayer insulating layer 123 is provided. Note that the third interlayer insulating layer 123 is not disposed at the bottom of the first contact hole CH1.

In the reflective region Rf of each pixel P, the reflective layer 140 is disposed on the observation face side of a fourth interlayer insulating layer 124. The low-reflective layer 130 is disposed on the back face side of the reflective layer 140, and a third transparent electrode E3 is disposed on the back face side of the low-reflective layer 130. A second contact hole CH2 is provided at the fourth interlayer insulating layer 124, and the first transparent electrode E1 is connected to the third transparent electrode E3 through the second contact hole CH2. The first transparent electrode E1 and the third transparent electrode E3 are preferably the pixel electrodes PE.

The low-reflective layer 130 may be a metal layer made of an electrically conductive metal (see the first embodiment), or may be a multilayer film including the metal layer 131 made of an electrically conductive metal and the transparent insulating layer 132 (see the second embodiment). When the low-reflective layer 130 is the multilayer film described above, the low-reflective layer 130 is not disposed at the bottom of the second contact hole CH2 (see the second embodiment).

### Fourth Embodiment

In the present embodiment, the first substrate 10 includes a flattening film 126 on the observation face side of the reflective layer 140. Since the present embodiment is substantially similar to the first or second embodiment except for this point and a layer forming the holding capacitance Cst, description of matters common to those of the first and second embodiments will be omitted.

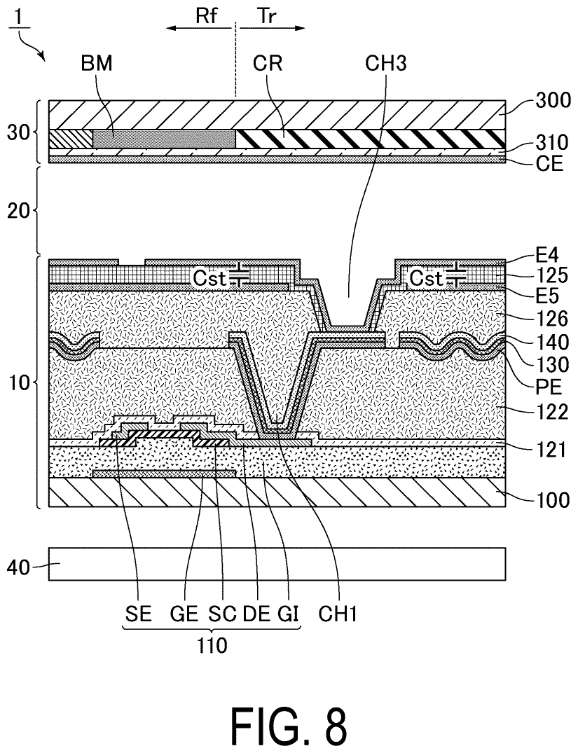

FIG. 8 is a schematic cross-sectional view of a pixel included in the display device 1 according to the present embodiment. As in the first and second embodiments, the first interlayer insulating layer 121 is disposed so as to cover the TFT 110, the second interlayer insulating layer 122 is disposed on the observation face side of the first interlayer insulating layer 121, the first contact hole CH1 is formed at the second interlayer insulating layer 122, and the TFT electrode and the pixel electrode PE are connected to each other through the first contact hole CH1. In the present embodiment, the flattening film 126 is disposed on the observation face side of the reflective layer 140. The flattening film 126 is preferably disposed not only in the reflective region Rf but also in the transmissive region Tr. The flattening film 126 is preferably an insulating film, more preferably an organic insulating film. Details of the organic insulating film are as described above.

A first transparent electrode E4 is disposed on the observation face side of the flattening film 126, and the first transparent electrode E4 overlaps the reflective layer 140 at the bottom of a second contact hole CH3 formed at the flattening film 126. Between the flattening film 126 and the first transparent electrode E4, a second transparent electrode E5 (a common potential) forming the holding capacitance Cst with the first transparent electrode E4 is disposed. Further, between the first transparent electrode E4 and the second transparent electrode E5, a third interlayer insulating layer 125 is provided. Note that the third interlayer insulating layer 125 is not disposed at the bottom of the second contact hole CH2. The first transparent electrode E4 is preferably a pixel electrode.

Disposing the flattening film 126 on the observation face side of the reflective layer 140 allows an interface between the first substrate 10 and the display layer 20 to have a flat shape. Thus, since the holding capacitance is formed in the flat region, the display device 1 according to the present embodiment has a stabilized capacitance, and thus the display quality does not deteriorate so that the display device 1 can have high quality.

The low-reflective layer 130 may be a metal layer made of an electrically conductive metal (see the first embodiment), or may be a multilayer film including the metal layer 131 made of an electrically conductive metal and the transparent insulating layer 132 (see the second embodiment). When the low-reflective layer 130 is the multilayer film described above, the low-reflective layer 130 is not disposed at the bottom of the second contact hole CH2 (see the second embodiment).

### Fifth Embodiment

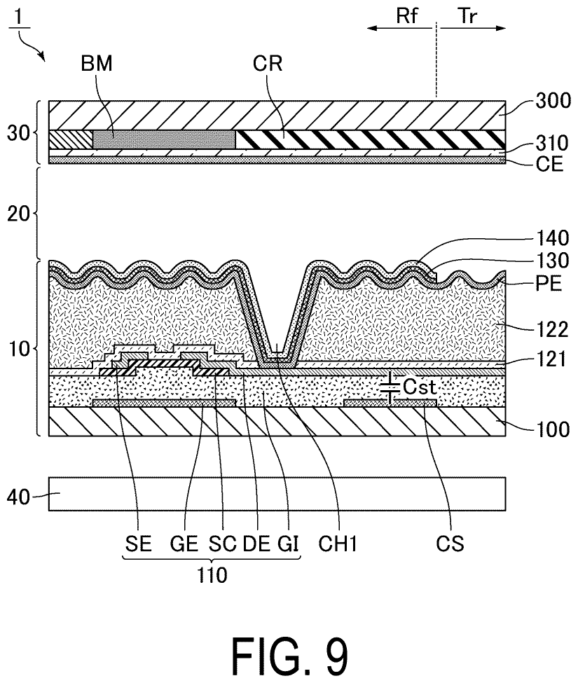

In the display device 1 according to the present embodiment, in the reflective region Rf of each pixel P, an interlayer insulating layer is provided between the TFT 110 and the low-reflective layer 130, and the reflective layer 140 and the low-reflective layer 130 are disposed at a position overlapping the gate electrode GE of the TFT 110 in a plan view (see FIG. 9). The present embodiment is substantially the same as the first, second, third, or fourth embodiment except for this point, and thus description of matters common to the first, second, third, and fourth embodiments will be omitted.

In the first to fourth embodiments, the reflective layer 140 and the low-reflective layer 130 are disposed at a position not overlapping the gate electrode GE in a plan view (see FIG. 2, FIG. 4, FIG. 7, and FIG. 8), but may be disposed at a position overlapping the gate electrode GE in a plan view (see FIG. 9). FIG. 9 is a schematic cross-sectional view of a pixel included in the display device 1 according to an example of the present embodiment.

The low-reflective layer 130 may be a metal layer made of an electrically conductive metal (see the first embodiment), or may be a multilayer film including the metal layer 131 made of an electrically conductive metal and the transparent insulating layer 132 (see the second embodiment). When the low-reflective layer 130 is the multilayer film described above, the low-reflective layer 130 is not disposed at the bottom of the second contact hole CH2 (see the second embodiment).

### Sixth Embodiment

As described in the first embodiment, one or more transparent layers 150 may be interposed between the low-reflective layer 130 and the reflective layer 140. The present embodiment is substantially similar to the first, second, third, fourth, or fifth embodiment except that a transparent layer 150 is provided between the low-reflective layer 130 and the reflective layer 140, and thus description of matters common to those of the first, second, third, fourth, or fifth embodiment will be omitted.

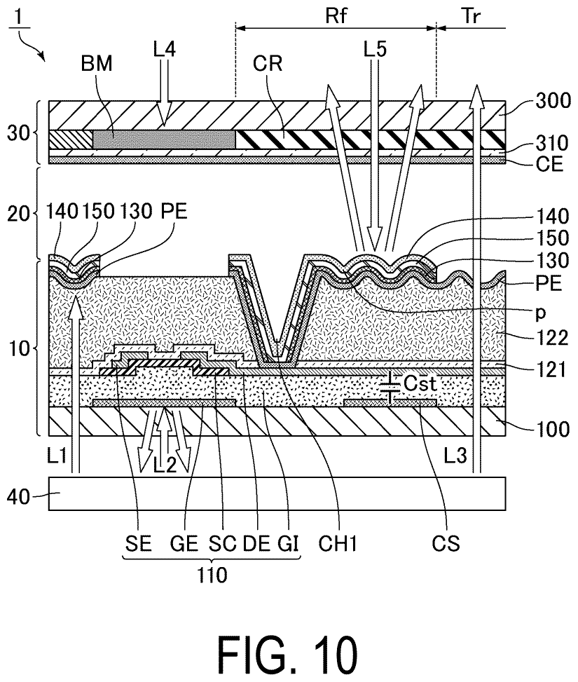

FIG. 10 is a schematic cross-sectional view of a pixel included in the display device 1 according to the present embodiment. FIG. 10 illustrates, as an example, an aspect in which one transparent layer 150 is provided between the low-reflective layer 130 and the reflective layer 140 in the display device 1 according to the first embodiment.

The transparent layer 150 is preferably an adhesive layer for allowing the low-reflective layer 130 and the reflective layer 140 to be in close contact with each other. Specifically, the transparent layer 150 is preferably a transparent electrode or a transparent insulating layer. Examples of the transparent electrode include those described above, and among them, an electrode made of Indium Tin Oxide (ITO) is preferable. The transparent insulating layer is preferably a layer made of an organic insulating material or an inorganic insulating material, and details of films obtained using these materials are as described above. In particular, the transparent insulating layer is preferably an inorganic insulating film, more preferably a nitride film (for example, a silicon nitride film).

Although the embodiments of the disclosure have been described above, all the individual matters described above can be applied to the entirety of the disclosure.

The display device 1 according to the disclosure will be described in more detail with reference to Examples and the like below, but the display device 1 according to the disclosure is not limited to only aspects of Examples. Note that simulations were performed by calculation based on the Frenel equations in an Excel sheet.

### Comparative Example 1

The liquid crystal display device 1R having a pixel structure illustrated in FIG. 11 was assumed, and the polar angle dependence of reflectivities of light from the backlight unit was simulated. An ITO film was used as the transparent electrode, an organic insulating film (with a film thickness of 2000 nm) was used as the second interlayer insulating layer 122, and an aluminum film (with a film thickness of 100 nm) was used as the reflective layer 140. FIG. 11 is a schematic cross-sectional view of a pixel included in the liquid crystal display device 1R according to Comparative Example 1 and Comparative Example 2. An angle α in FIG. 11 is a polar angle of the reflected light of light from the backlight unit, and more specifically, is an angle formed between a traveling direction of light from the backlight unit and a traveling direction of the reflected light of the light from the backlight unit.

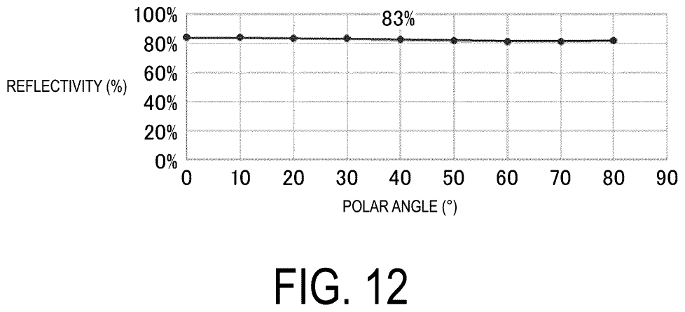

FIG. 12 is a graph showing a simulation result for the present example. As can be seen from FIG. 12, the reflectivity is 80% or more at any polar angle and an irradiation amount to the TFT channel portion is large. For example, when light from the backlight unit is irradiated at 10,000 cd/m², it is calculated that the reflected light thereof is irradiated at 0.71 W/m² per one element of the TFT. As a result, when the liquid crystal display device 1R is driven at 1 Hz, it is presumed that the display quality is poor.

### Comparative Example 2

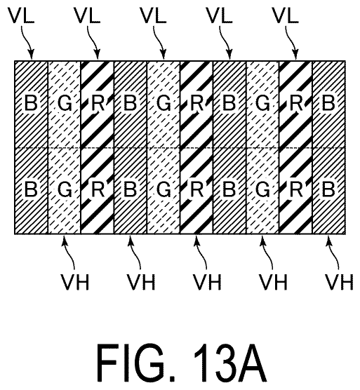

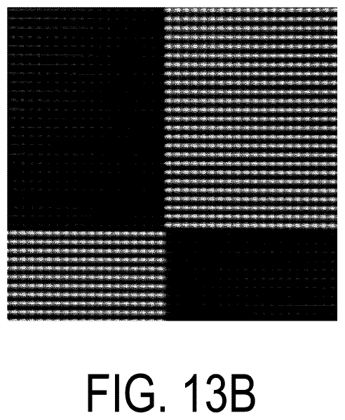

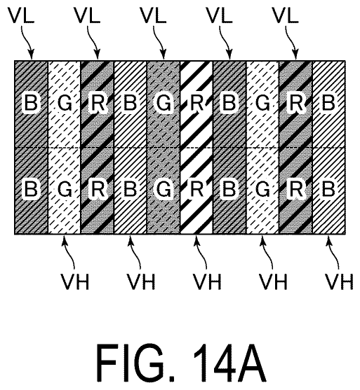

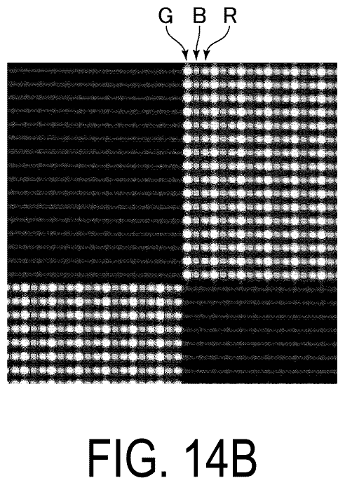

The liquid crystal display device 1R assumed in Comparative Example 1 was prepared. This liquid crystal display device 1R was driven at 60 Hz or 0.01 Hz, the backlight was made in an ON state (that is, the light from the backlight unit was turned on), the liquid crystal display device was placed in a thermostatic chamber at 60° C., and an accelerated aging test was carried out. In this case, a white luminance after the test was reduced by about 50% relative to a white luminance before the test in the example (Comparative Example 2-2) in which the liquid crystal display device 1R was driven at 0.01 Hz. According to microscopic observation of the pixel at this time, it was found that the white luminance of the pixel to which the VL signal, of input signals of the high-level voltage VH and the low-level voltage VL, was input extremely decreased (see FIG. 14B). On the other hand, no abnormality was observed in the example (Comparative Example 2-1) in which the liquid crystal display device 1R was driven at 60 Hz (see FIG. 13B).

FIG. 13A is a diagram conceptually illustrating signals input to respective pixels (RGB) included in the liquid crystal display device 1R according to Comparative Example 2-1 (that is, the liquid crystal display device 1R driven at 60 Hz), and FIG. 13B is a close-up photograph of a black-and-white pattern after the liquid crystal display device 1R according to Comparative Example 2-1 was subjected to the accelerated aging test. FIG. 14A is a diagram conceptually illustrating signals input to respective pixels (RGB) included in the liquid crystal display device 1R according to Comparative Example 2-2 (that is, the liquid crystal display device 1R driven at 0.01 Hz), and FIG. 14B is a close-up photograph of a black-and-white pattern after the liquid crystal display device 1R according to Comparative Example 2-2 was subjected to the accelerated aging test. R means a red pixel, G means a green pixel, and B means a blue pixel.

### Example 1

The liquid crystal display device 1 having the pixel structure illustrated in FIG. 2 was assumed, and the polar angle dependence of reflectivities of light from the backlight unit was simulated. An ITO film (with a film thickness of 100 nm) was used as the transparent electrode (PE), an organic insulating film (with a film thickness of 2000 nm) was used as the second interlayer insulating layer 122, a Mo film (with a film thickness of 10 nm or 100 nm) was used as the low-reflective layer 130, and an aluminum film (with a film thickness of 100 nm) was used as the reflective layer 140. Note that as the low-reflective layer 130, a Mo film (with a film thickness of 10 nm) was used in Example 1-1, and a Mo film (with a film thickness of 100 nm) was used in Example 1-2.

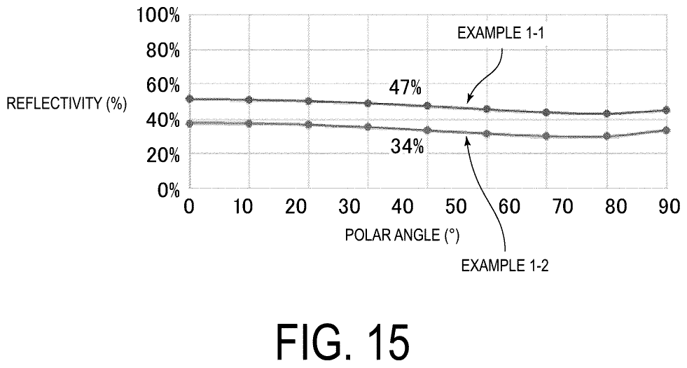

FIG. 15 is a graph showing simulation results for the present example. As can be seen from FIG. 15, with the configuration of the present example, even when the reflected light of light from the backlight unit hits the TFT 110, reflectivities thereof are sufficiently lower than those of Comparative Example 1. That is, an irradiation amount to the TFT channel portion is significantly reduced as compared with Comparative Example 1. For example, when light from the backlight unit is irradiated at 10,000 cd/m², it is calculated that the reflected light thereof is irradiated at 0.40 W/m² per one element of the TFT in Example 1-1, and is irradiated at 0.29 W/m² per one element of the TFT in Example 1-2. As a result, it is presumed that the liquid crystal display device 1 of the present example has high display quality.

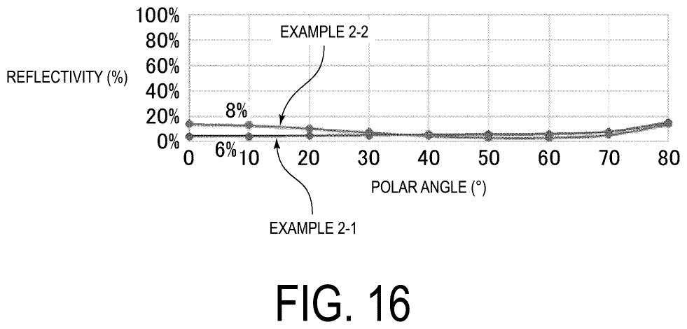

Note that in the drawings, the reflectivities (%) denoted above and below each graph are average reflectivities within a range of polar angles from 0° to 80° (the same applies to FIG. 16 to FIG. 20, which will be described later). For example, “47%” denoted above the graph of Example 1-1 means the average reflectivity within a range of polar angles from 0 to 80° in Example 1-1, and “34%” denoted below the graph of Example 1-2 means the average reflectivity within a range of polar angles from 0 to 80° in Example 1-2.

### Example 2

The liquid crystal display device 1 having the pixel structure illustrated in FIG. 4 was assumed, and the polar angle dependence of reflectivities of light from the backlight unit was simulated. An ITO film (with a film thickness of 100 nm) was used as the transparent electrode (PE), an organic insulating film (with a film thickness of 2000 nm) was used as the second interlayer insulating layer 122, a layered film of a Mo film (with a film thickness of 5 nm), a SiN film (with a film thickness of 50 nm or 100 nm), and a W film (with a film thickness of 100 nm) was used as the low-reflective layer 130, and an aluminum film (with a film thickness of 100 nm) was used as the reflective layer 140. Note that as the low-reflective layer 130, a layered film of a Mo film (with a film thickness of 5 nm), a SiN film (with a film thickness of 50 nm), and a W film (with a film thickness of 100 nm) was used in Example 2-1, and a layered film of a Mo film (with a film thickness of 5 nm), a SiN film (with a film thickness of 100 nm), and a W film (with a film thickness of 100 nm) was used in Example 2-2.

FIG. 16 is a graph showing simulation results for the present example. As can be seen from FIG. 16, reflectivities of light from the backlight unit are significantly reduced with the configuration of the present example. That is, an irradiation amount to the TFT channel portion is significantly small. For example, when light from the backlight unit is irradiated at 10,000 cd/m², it is calculated that the reflected light is irradiated at 0.08 W/m² per one element of the TFT in Example 2-1, and is irradiated at 0.03 W/m² per one element of the TFT in Example 2-2. When the reflectivity is significantly low as described above, even when the liquid crystal display panel is driven at 1 Hz, an observer cannot visually recognize flickering.

In order to examine a relationship between the SiN film and the reflectivity, simulations as described above were performed by changing the film thicknesses of the SiN film. The liquid crystal display device 1 of Example 2-3 is an example in which the film thickness of the SiN film in the low-reflective layer 130 is changed to 300 nm in the liquid crystal display device 1 of Example 2-1 (or Example 2-2), and the liquid crystal display device 1 of Example 2-4 is an example in which the film thickness of the SiN film in the low-reflective layer 130 is changed to 500 nm in the liquid crystal display device 1 of Example 2-1 (or Example 2-2).

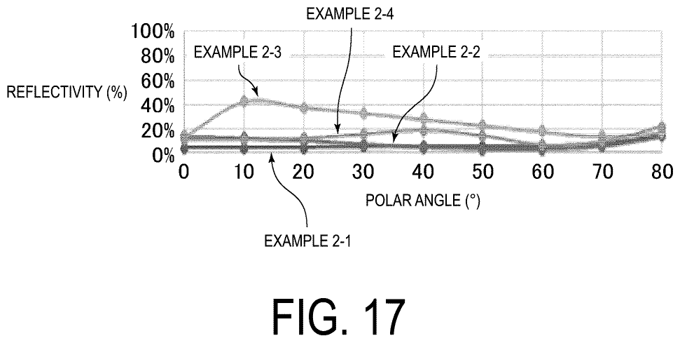

FIG. 17 is a graph showing simulation results for the present example. In this graph, both the results of Example 2-1 and Example 2-2 are also shown. Average reflectivities within a range of polar angles from 0 to 80° were as follows.
Example 2-1: 5.80%
Example 2-2: 7.55%
Example 2-3: 15.88%
Example 2-4: 13.01%

### Example 3

The liquid crystal display device 1 having the pixel structure illustrated in FIG. 10 was assumed, and the polar angle dependence of reflectivities of light from the backlight unit was simulated. An ITO film (with a film thickness of 50 nm) was used as the transparent electrode (PE), an organic insulating film (with a film thickness of 2000 nm) was used as the second interlayer insulating layer 122, a Ti film (with a film thickness of 5 nm or 10 nm) was used as the low-reflective layer 130, an ITO film (with a film thickness of 50 nm) was used as the transparent layer 150, and an Ag film (with a film thickness of 100 nm) was used as the reflective layer 140. Note that as the low-reflective layer 130, a Ti film (with a film thickness of 5 nm) was used in Example 3-1, and a Ti film (with a film thickness of 10 nm) was used in Example 3-2.

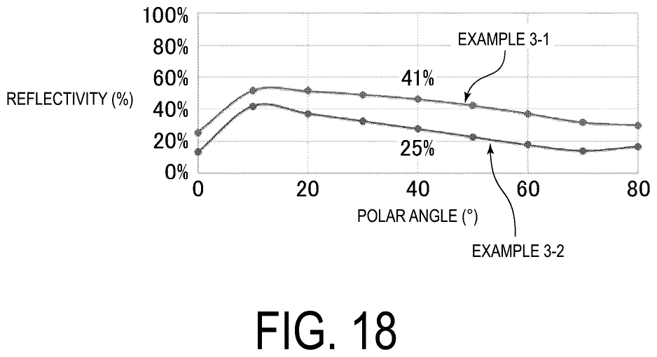

FIG. 18 is a graph showing simulation results for the present example. As can be seen from FIG. 18, reflectivities of light from the backlight unit are significantly reduced with the configuration of the present example. That is, an irradiation amount to the TFT channel portion is significantly small. For example, when the light from the backlight unit is irradiated at 10,000 cd/m², it is calculated that the reflected light thereof is irradiated at 0.34 W/m² per one element of the TFT in Example 3-1, and is irradiated at 0.21 W/m² per one element of the TFT in Example 3-2. When the reflectivity is significantly low as described above, even when the liquid crystal display panel is driven at 1 Hz, an observer cannot visually recognize flickering.

### Example 4

The liquid crystal display device 1 having the pixel structure illustrated in FIG. 10 was assumed, and the polar angle dependence of reflectivities of the light from the backlight unit was simulated. An ITO film (with a film thickness of 50 nm) was used as the transparent electrode (PE), an organic insulating film (with a film thickness of 2000 nm) was used as the second interlayer insulating layer 122, a Mo film (with a film thickness of 5 nm or 10 nm) was used as the low-reflective layer 130, an ITO film (with a film thickness of 50 nm) was used as the transparent layer 150, and an Ag film (with a film thickness of 100 nm) was used as the reflective layer 140. Note that as the low-reflective layer 130, a Mo film (with a film thickness of 5 nm) was used in Example 4-1, and a Mo film (with a film thickness of 10 nm) was used in Example 4-2.

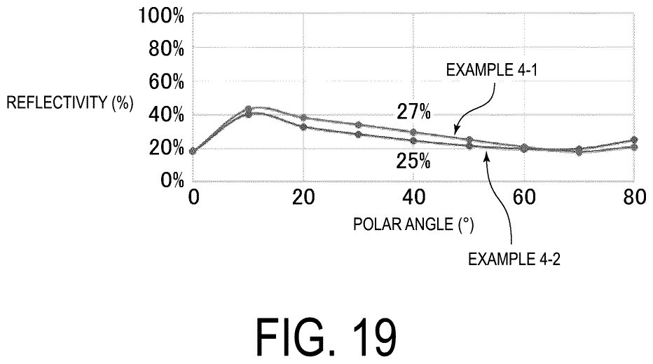

FIG. 19 is a graph showing simulation results for the present example. As can be seen from FIG. 19, reflectivities of light from the backlight unit are significantly reduced with the configuration of the present example. That is, an irradiation amount to the TFT channel portion is significantly small. For example, when light of the backlight unit is irradiated at 10,000 cd/m², it is calculated that the reflected light thereof is irradiated at 0.23 W/m² per one element of the TFT in Example 4-1, and is irradiated at 0.21 W/m² per one element of the TFT in Example 4-2. When the reflectivity is significantly low as described above, even when the liquid crystal display panel is driven at 1 Hz, an observer cannot visually recognize flickering.

### Example 5

The liquid crystal display device 1 having the pixel structure illustrated in FIG. 10 was assumed, and the polar angle dependence of reflectivities of light from the backlight unit was simulated. An ITO film (with a film thickness of 50 nm) was used as the transparent electrode (PE), an organic insulating film (with a film thickness of 2000 nm) was used as the second interlayer insulating layer 122, a Ti film (with a film thickness of 5 nm or 10 nm) was used as the low-reflective layer 130, a SiNx film (with a film thickness of 50 nm) was used as the transparent layer 150, and an Ag film (with a film thickness of 100 nm) was used as the reflective layer 140. Note that as the low-reflective layer 130, a Ti film (with a film thickness of 5 nm) was used in Example 5-1, and a Ti film (with a film thickness of 10 nm) was used in Example 5-2.

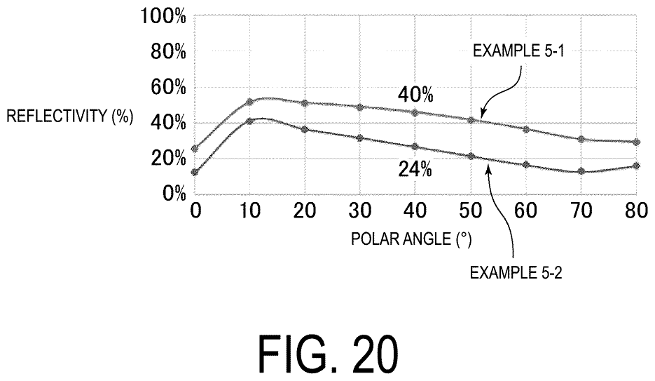

FIG. 20 is a graph showing simulation results for the present example. As can be seen from FIG. 20, reflectivities of light from the backlight unit are significantly reduced with the configuration of the present example. That is, an irradiation amount to the TFT channel portion is significantly small. For example, when light from the backlight unit is irradiated at 10,000 cd/m², it is calculated that the reflected light thereof is irradiated at 0.33 W/m² per one element of the TFT in Example 5-1, and is irradiated at 0.20 W/m² per one element of the TFT in Example 5-2. When the reflectivity is significantly low as described above, even when the liquid crystal display panel is driven at 1 Hz, an observer cannot visually recognize flickering.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A display device comprising:
a light source, a first substrate including a switching element including an oxide semiconductor layer, a display layer, and a second substrate in this order from a back face side to an observation face side; and
a plurality of pixels arranged in a matrix in a display region,
wherein the first substrate includes a reflective layer provided on the observation face side relative to the switching element, and a low-reflective layer disposed on the back face side of the reflective layer,
at least a surface of the reflective layer on the back face side has an uneven shape, and
each of the plurality of pixels includes a reflective region and a transmissive region, the reflective region is configured to reflect light at the reflective layer and to perform display, and the transmissive region is configured to transmit light and to perform display.

2. The display device according to claim 1,
wherein the low-reflective layer is disposed in contact with the reflective layer.

3. The display device according to claim 1,
wherein the first substrate includes an interlayer insulating layer between a source bus line and a drain wiring line each of which is electrically connected to the switching element and the low-reflective layer.

4. The display device according to claim 1,
wherein the first substrate includes an interlayer insulating layer on the observation face side of the switching element,
each of the pixels includes a pixel electrode electrically connected to the switching element through a contact hole provided at the interlayer insulating layer, and
in the reflective region of each of the pixels, the low-reflective layer and the pixel electrode are disposed on the back face side of the reflective layer in an order of the low-reflective layer and the pixel electrode.

5. The display device according to claim 1,
wherein the low-reflective layer is a metal layer made of a metal having a reflectivity of 50% or less when measured at a film thickness of 200 nm.

6. The display device according to claim 1,
wherein the low-reflective layer is a multilayer film including a metal layer and a transparent insulating layer, and the metal layer is made of a metal having a reflectivity of 50% or less when measured at a film thickness of 200 nm.

7. The display device according to claim 4,
wherein the low-reflective layer is a multilayer film including a metal layer and a transparent insulating layer, and the metal layer is made of a metal having a reflectivity of 50% or less when measured at a film thickness of 200 nm, and
the low-reflective layer is not disposed at a bottom of the contact hole.

8. The display device according to claim 5,
wherein the low-reflective layer has a planar pattern being substantially identical to a planar pattern of the reflective layer, when viewed from the observation face side.

9. The display device according to claim 7,
wherein a portion other than a portion provided with the contact hole, of the low-reflective layer, has a planar pattern being substantially identical to a planar pattern of the reflective layer when viewed from the observation face side.

10. The display device according to claim 5,
wherein the metal is at least one selected from the group consisting of titanium, copper, molybdenum, and tungsten, or an alloy of the at least one selected from the group.

11. The display device according to claim 6,
wherein the metal is at least one selected from the group consisting of titanium, copper, molybdenum, and tungsten, or an alloy of the at least one selected from the group,
the transparent insulating layer is a nitride film, and
the multilayer film includes the metal layer and the nitride film.

12. The display device according to claim 7,
wherein the metal is at least one selected from the group consisting of titanium, copper, molybdenum, and tungsten, or an alloy of the at least one selected from the group,
the transparent insulating layer is a nitride film, and
the multilayer film includes the metal layer and the nitride film.

13. The display device according to claim 1,
wherein at least a surface of the low-reflective layer on the back face side has an uneven shape.

14. The display device according to claim 1,
wherein the first substrate includes a flattening film on the observation face side of the reflective layer.

15. The display device according to claim 1,
wherein in the reflective region of each of the pixels, an interlayer insulating layer is provided between the switching element and the low-reflective layer, and the reflective layer and the low-reflective layer are disposed at a position overlapping a gate electrode of the switching element in a plan view.

16. The display device according to claim 1,
wherein the display layer is a liquid crystal layer.

17. The display device according to claim 1, further comprising:
a drive circuit configured to drive the display device,
wherein the drive circuit is configured to switch between a first drive mode and a second drive mode, and in the first drive mode, the display device is configured to be driven at a first frequency, and in the second drive mode, the display device is configured to be driven at a second frequency lower than the first frequency.

18. The display device according to claim 17,
wherein the light source is turned on in the second drive mode.

19. The display device according to claim 1,
wherein the oxide semiconductor layer includes InGaZnOx including indium (In), gallium (Ga), zinc (Zn), and oxygen (O) as main components.
